(19) United States
(12) Patent Application Publication
(10) Pub. No.: US 2010/0033498 A1
(43) Pub. Date: Feb. 11, 2010

(54) ELECTRONIC APPARATUS HAVING DISPLAY DEVICE

(75) Inventors: Masanori Terasaki, Tokyo (JP); Atsuo Shono, Tokyo (JP); Koji Takano, Tokyo (JP); Takehiko Tanaka, Tokyo (JP); Kohei Kashima, Tokyo (JP); Yoshiaki Sato, Tokyo (JP); Yusuke Ogura, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/406,848

(22) Filed: Mar. 18, 2009

(30) Foreign Application Priority Data
Aug. 6, 2008 (JP) 2008-203290

(51) Int. Cl. G09G 5/00

(52) U.S. Cl. 345/617

(57) ABSTRACT

An electronic apparatus having a display device, an operation section, an area setting section and a brightness adjuster is provided. The display device is configured to display an image and text. The operation section configured to be used for input operation. The area setting section is configured to set a noticed area on a screen displayed on the display device on the basis of an input operation done on the operation section. The brightness adjuster is configured to make an unnoticed area of the screen less bright than the noticed area.

### CROSS REFERENCE TO RELATED APPLICATIONS

This application is based upon and claims the benefit of priority from the prior Japanese Patent Application No. 2008-203290 filed on Aug. 6, 2008; the entire contents of which are incorporated herein by reference.

### BACKGROUND OF THE INVENTION

1. Field of the Invention

The present invention relates to an electronic apparatus, and in particular to an electronic apparatus having a display device, and configured to display a screen including text or an image.

2. Description of the Related Art

Electronic apparatuses configured to display screens such as personal computers, mobile phones, portable game machines and so on have become information/amusement tools indispensable to daily lives. It is important for these electronic apparatuses to provide easy-to-operate user interfaces as well as to display various images and text, as disclosed in, e.g., Japanese Patent Publication of Unexamined Applications (Kokai), No. 2006-350490, and No. 2005-321896.

JP 2006-350490 discloses a graphical user interface (GUI) screen having a layered structure formed by a plurality of layers. As a degree of transparency may be set for each of the layers, the GUI screen may form an image that would be drawn on an overhead transparency and projected by an overhead projector (OHP). According to JP 2006-350490, each of processes of various events following operations may be separately associated with each of the layers, so that the layers are highly independent and that functions relating to the GUI may be easily added or deleted.

JP 2005-321896 discloses a method, in a case where a plurality of icons corresponding to different functions each are displayed in a same menu screen, for highlighting and drawing attention to one of the icons corresponding to one of the functions being selected rather than the other icons. The selected icon may be highlighted by changing its color, size, brightness and so on. JP 2005-321896 describes that a user may intuitively understand which menu item is being selected and displayed.

As being a common information tool, each of various electronic apparatuses has to display a screen for providing an easy-to-operate user interface, and has to save power for the display operation as well particularly in a mobile circumstance. Although the GUI of JP 2006-350490 is intended to be easy-to-operate, power saving has to be considered in addition.

The method disclosed in JP 2005-321896 is intended to make the display of the noticed area of the screen easy-to-see by distinguishing it from the unnoticed area, from a standpoint of the easy-to-operate user interface as well as JP 2006-350490. Thus, power saving has to be considered in addition.

### SUMMARY OF THE INVENTION

Accordingly, an advantage of the present invention is to set noticed and unnoticed areas on a screen displayed by an electronic apparatus and to make the unnoticed area less bright, so that the noticed area may be made easier-to-see than usual.

To achieve the above advantage, one aspect of the present invention is to provide an electronic apparatus having a display device, an operation section, an area setting section and a brightness adjuster. The display device is configured to display an image and text. The operation section configured to be used for input operation. The area setting section is configured to set a noticed area on a screen displayed on the display device on the basis of an input operation done on the operation section. The brightness adjuster is configured to make an unnoticed area of the screen less bright than the noticed area.

### BRIEF DESCRIPTION OF THE DRAWINGS

FIG. 1 is an external (front) view of a mobile communication device, i.e., an electronic apparatus of a first embodiment of the present invention.

FIG. 2 is a block diagram of the mobile communication device of the first embodiment.

FIG. 3 is a block diagram of a display controller of the mobile communication device of the first embodiment.

FIG. 4 is a block diagram of a pixel processor included in the display controller of the mobile communication device of the first embodiment.

FIG. 5 illustrates a concept of a layered structure and combination of screens controlled by the pixel processor of the first embodiment.

FIG. 6 illustrates the concept of the first embodiment shown in FIG. 5, showing that a first layer is made relatively less bright.

FIG. 7 illustrates the concept of the first embodiment shown in FIG. 6, showing that a noticed area is magnified.

FIG. 8 is a block diagram of a mobile communication device of a second embodiment of the present invention.

FIG. 9 is a block diagram of a display controller of the mobile communication device of the second embodiment.

FIG. 10 is a block diagram of a distance calculator included in the display controller of the mobile communication device of the second embodiment.

FIG. 11 illustrates on a screen an output of the distance calculator of the second embodiment.

FIG. 12 is a block diagram of a pixel processor included in the display controller of the mobile communication device of the second embodiment.

### DETAILED DESCRIPTION OF THE INVENTION

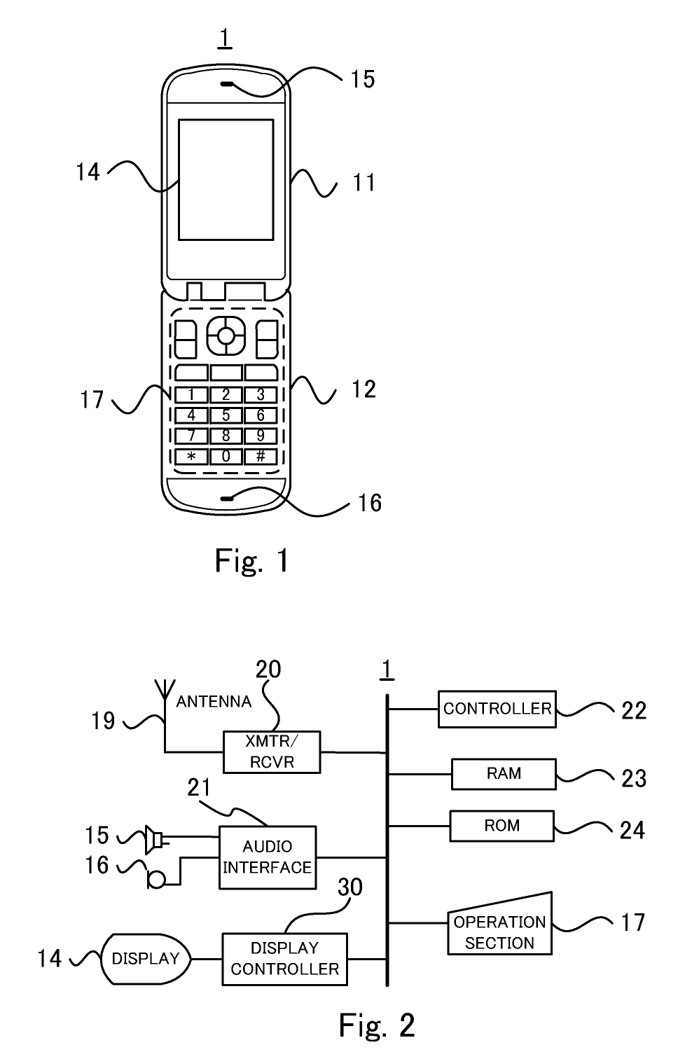

A first embodiment of the present invention will be described with reference to FIGS. 1-7. FIG. 1 is an external (front) view of a flip type mobile communication device 1, i.e., an electronic apparatus of the first embodiment. The mobile communication device 1 is constituted by a first section 11 and a second section 12 which are connected in such a way as to be open or closed to each other.

The first section 11 has a display device 14 formed by, e.g., an organic electro-luminescence device. The display device 14 may display text and an image. The mobile communication device 1 may perform an application accompanied by a display of a screen (e.g., sending and receiving an email, web browsing, making and using a directory, etc.) by using the display device 14. The first section 11 has an earpiece 15. The second section 12 has a microphone 16. As having the earpiece 15 and the microphone 16, the mobile communication device 1 may be used for voice communication.

The second section 12 has an operation section 17 (shown as surrounded by a dashed frame) constituted by a plurality of operation keys. The operation section 17 may include an operation key that is not shown and arranged on a back or side face of the first section 11 or the second section 12. Upon one of the operation keys of the operation section 17 being operated, the mobile communication device 1 may be operated so as to start or stop working, or may be provided with text or an operation command. Each of the display device 14, the earpiece 15, the microphone 16 and the operation section 17 may work as a user interface of the mobile communication device 1.

FIG. 2 is a block diagram of the mobile communication device 1. As having an antenna 19 and a transmitter/receiver 20, the mobile communication device 1 may send and receive a radio wave to and from a base station for mobile communication that is not shown. The mobile communication device 1 has an audio interface 21, a controller 22, a random access memory (RAM) 23 and a read-only memory (ROM) 24.

The controller 22 is constituted by a single chip of a processing device such as a microprocessor, or by a combination of a plurality of such chips. The RAM 23 is a memory on and from which the controller 22 may write or read a required program or data as necessary for performing a function. The ROM 24 is a memory on which programs or data are written beforehand.

Each of the transmitter/receiver 20, the audio interface 21, the RAM 23 and the ROM 24 is connected to the controller 22 through, e.g., a common bus so as to be monitored and controlled by the controller 22. The operation section 17 described with reference to FIG. 1 is similarly connected to the controller 22 through, e.g., the common bus so as to send a signal corresponding to an operation input to the controller 22. The display device 14 described with reference to FIG. 1 is similarly connected to, e.g., the common bus through a display controller 30 so as to display a screen in the control of the controller 22.

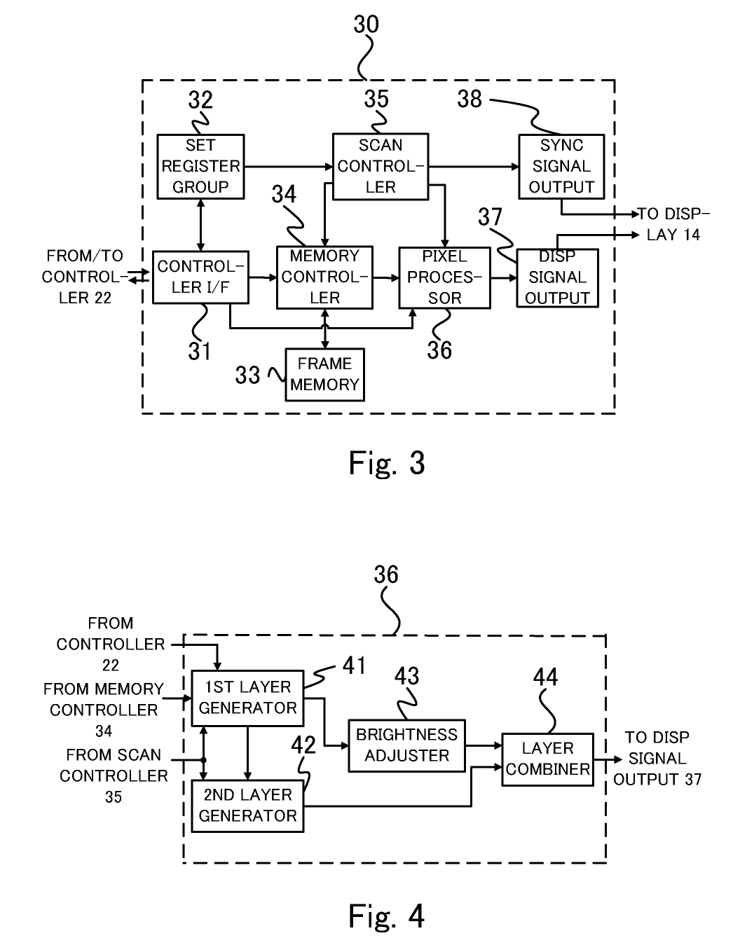

FIG. 3 is a block diagram of the display controller 30 having a controller interface 31, a set register group 32, a frame memory 33 and a memory controller 34. The set register group 32 is a collection of set registers each of which may store set values of the numbers of pixels in horizontal and vertical directions corresponding to resolution of a screen displayed on the display device 14, and of a blanking width of the screen. The frame memory 33 may store content data of the screen displayed on the display device 14 frame by frame.

The controller interface 31 may relay data to be written to or read out from one of the set registers of the set register group 32 in accordance with an instruction of the controller 22. The controller interface 31 may relay data to be written to the frame memory 33 through the memory controller 34 in accordance with an instruction of the controller 22.

The display controller 30 has a scan controller 35 and a pixel processor 36. The scan controller 35 may scan the pixels forming a screen displayed on the display device 14 on the basis of the set values of the parameters for display synchronization (the numbers of pixels in horizontal and vertical directions, and the blanking width) stored in the set register group 32. The scan controller 35 may instruct the memory controller 34 to read the display content data from the frame memory 33 for each of the pixels.

The pixel controller 36 may perform an arithmetic process described later on the data read from the frame memory 33 in synchronization with the scan operation of the scan controller 35. The controller 22 may inform the pixel processor 36, through the controller interface 31, of a position of a cursor displayed on the screen.

The display controller 30 has a display signal output section 37 and a synchronization signal output section 38. The display signal output section 37 may convert the screen data arithmetically processed by the pixel processor 36 into a display signal, and may provide the display device 14 with the display signal. The synchronization signal output section 38 may generate a synchronization signal on the basis of the scan operation of the scan controller 35, and may provide the display device 14 with the synchronization signal. The display device 14 may consequently display the screen content stored in the frame memory 33 as the data.

FIG. 4 is a block diagram of the pixel processor 36 having a first layer generator 41, a second layer generator 42, a brightness adjuster 43 and a layer combiner 44. The first layer generator 41 may receive the display content data which the memory controller 34 has read from the frame memory 33, and may receive a scan signal from the scan controller 35, so as to produce screen data of a first layer (ordinals of layers are not necessarily consistent with an up and down order of the layers shown in the drawings referred to later). The screen data of the first layer may be produced in accordance with a screen size of the display device 14.

The first layer generator 41 may receive the information of the cursor position from the controller 22 through the controller interface 31, so as to set a noticed area including the cursor position. The above noticed area is, e.g., a character pointed by the cursor, a series of characters including both sides of the cursor, or a whole line where the cursor is positioned.

The first layer generator 41 may inform the second layer generator 42 of the above noticed area. The second layer generator 42 may receive the scan signal from the scan controller 35. The second layer generator 42 may produce an opaque portion of screen data of a second layer in correspondence with a super-area including the noticed area. The second layer generator 42 may produce a transparent portion of the screen data of the second layer in correspondence with the outside of the super-area including the noticed area. The screen data of the second layer in which the opaque and transparent portions are combined may be produced in accordance with the screen size of the display device 14.

The layer combiner 44 may overlap and combine the screen data of the first layer and the screen data of the second layer in such a way that the screen of the second layer is positioned in front on the display device 14. Such combination of the layers is described in, e.g., JP 2006-350490.

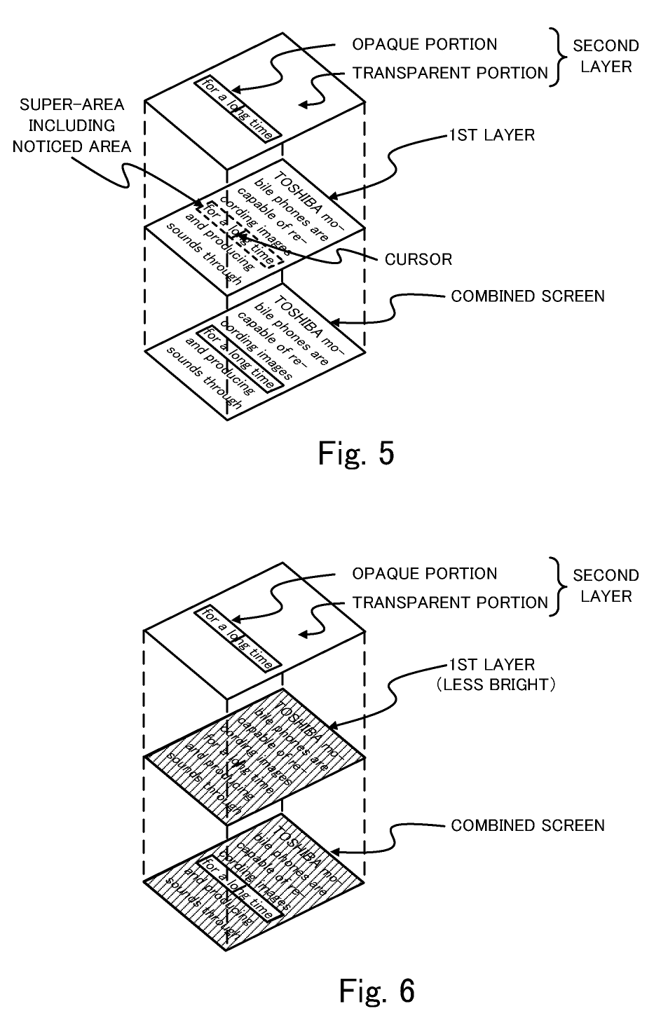

The layered structure and combination of the screens describe above will be explained with reference to FIG. 5 showing a concept of the layered structure and combination of the screens. The screen of the first layer shown in FIG. 5 is a screen of text, and is positioned second from the top. On the screen of the first layer, a ninth (counted including spaces) character “n” of a fifth line of the text “for a long time” is pointed by the cursor.

In this case, the noticed area of the screen of the first layer may be defined to be an area indicating the ninth character “n” of the fifth line, or a series of characters including both sides of the cursor such as “long”, or the whole fifth line. Whichever of the above the noticed area is, the super-area including the noticed area may be defined to be the whole fifth line (shown in FIG. 5 as surrounded by a dashed frame on the first layer).

Then, the screen of the second layer positioned at the top of FIG. 5 is formed by the opaque portion indicating text of “for a long time” corresponding to the fifth line of the first layer, and the transparent portion (no text is indicated) that is the outside of the opaque portion.

The screen of the second layer is positioned in front of and overlaps the screen of the first layer so that a combined screen shown at the bottom in FIG. 5 is produced. A portion of the combined screen other than the fifth line of the text (the outside of the super-area including the noticed area) may be viewed as included in the first layer through the transparent portion of the second layer. The fifth line (the super-area including the noticed area) may be viewed as included in the opaque portion of the second layer.

Although not having been referred to above with reference to FIG. 5, the brightness adjuster 43 may change and adjust brightness of the screen data of the first layer. A brightness value to be adjusted to may be provided by default, or may be instructed by the controller 22.

Brightness of the first layer may be changed in the process for combining the layered screens described above, and such a case will be described with reference to FIG. 6. Although FIG. 6 basically equals FIG. 5, the brightness of the first layer has been relatively reduced as shown by hatching in FIG. 6.

Then, on the combined screen at the bottom in FIG. 6, the fifth line of the text where the cursor is positioned may be viewed as included in the opaque portion of the second layer with ordinary brightness, and the portion other than the fifth line of the text (the outside of the super-area including the noticed area) may be viewed as included in the first layer that has been made relatively less bright through the transparent portion of the second layer.

The super-area including the noticed area where the cursor is positioned may consequently be highlighted so as to make the screen easy-to-see. If being formed by including a self-luminescent element such as an organic electro-luminescence device, the display device 14 may effectively save power by showing the outside of the super-area including the noticed area to be relatively less bright.

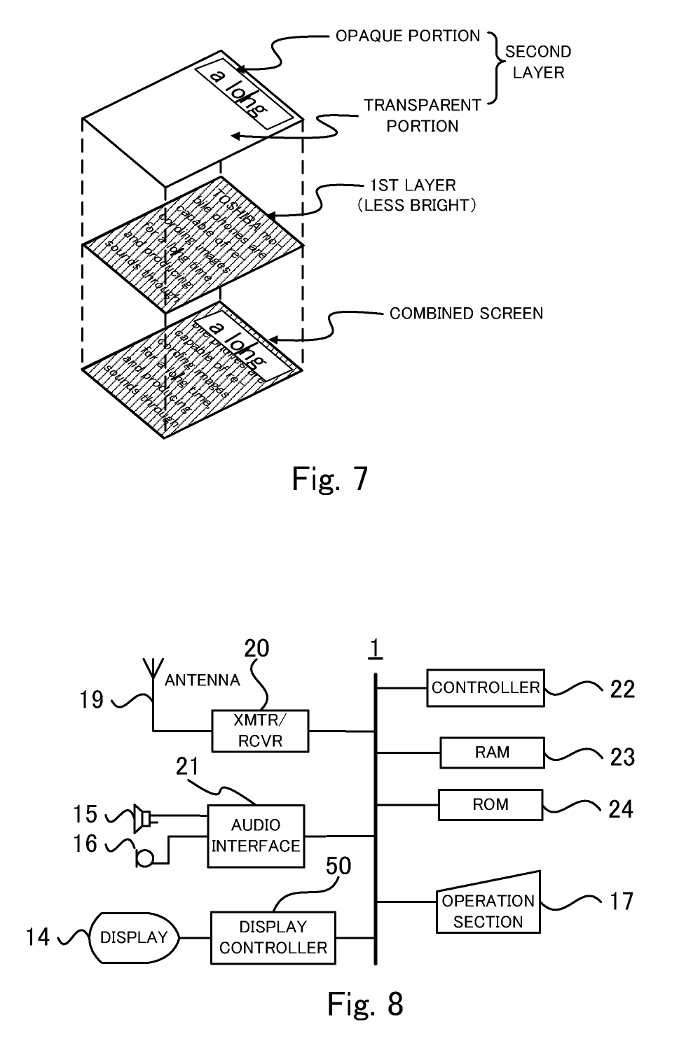

The first embodiment may be modified in such a way that the display of the opaque portion of the second layer may coincide with a magnified display of the noticed area of the first layer (i.e., so called a magnifying glass). FIG. 7 shows a concept of such a modification. The screen of the first layer shown in FIG. 7 includes the cursor pointing the character “n” of the fifth line similarly as in FIG. 6, and is shown to be relatively less bright.

The screen of the second layer is formed by the opaque portion magnifying a series of characters “a long” including both sides of the character “n” of the fifth line of the first layer (magnifying glass), and the transparent portion (no text is indicated) that is the outside of the opaque portion. The magnifying glass is supposed to be positioned at the top of the screen.

Then, on the combined screen shown at the bottom in FIG. 7, a portion of the fifth line of the text where the cursor is positioned is magnified and displayed at the top of the screen with the ordinary brightness, and the portion of the first layer not overlaid with the magnifying glass is displayed with relatively lower brightness.

The first embodiment may also be modified in such a way that the screen of the first layer is not a screen for displaying text as shown in FIGS. 5-7, but is a screen constituted in such a way that icons for selecting functions are two-dimensionally arranged and one of the icons may be pointed by the cursor and selected. On such a screen, the area pointed by or including the cursor may be defined as a noticed area so that a super-area including the noticed area and the outside of the super-area may be displayed with ordinary brightness and relatively lower brightness, respectively. The noticed area may be magnified and displayed with different brightness.

The first embodiment may still be modified in such a way that the noticed area may be displayed in a phased manner. On the screen for displaying text, e.g., a character pointed by the cursor, other characters of the line where the cursor is positioned, and lines other than the line where the cursor is positioned may be displayed with ordinary brightness, slightly lower brightness and lowest brightness, respectively. These areas may be distinguished from one another by changing color. In order to implement such a modification, the second layer generator 42 shown in FIG. 4 should be followed by a section for setting the brightness or the color.

According to the first embodiment of the present invention described above, the screen to be displayed may be layer-structured so as to be divided into the noticed area and the unnoticed area, and the unnoticed area may be displayed with relatively lower brightness. The noticed area may be easy-to-see and the power may be effectively saved at the same time, thereby.

A second embodiment of the present invention will be described with reference to FIGS. 8-12. FIG. 8 is a block diagram of a mobile communication device 2, i.e., an electronic apparatus of the second embodiment. The mobile communication device 2 has a same casing structure and an external view as the mobile communication device 1 of the first embodiment. The mobile communication device 2 is constituted by replacing the display controller 30 of the mobile communication device 1 with a display controller 50 having a different configuration, and by adopting same portions as the mobile communication device 1 shown in FIG. 2 except the display controller 50, having same reference numerals and same interconnections. Thus, explanations of the portions shown in FIG. 8 except the display controller 50 will be omitted.

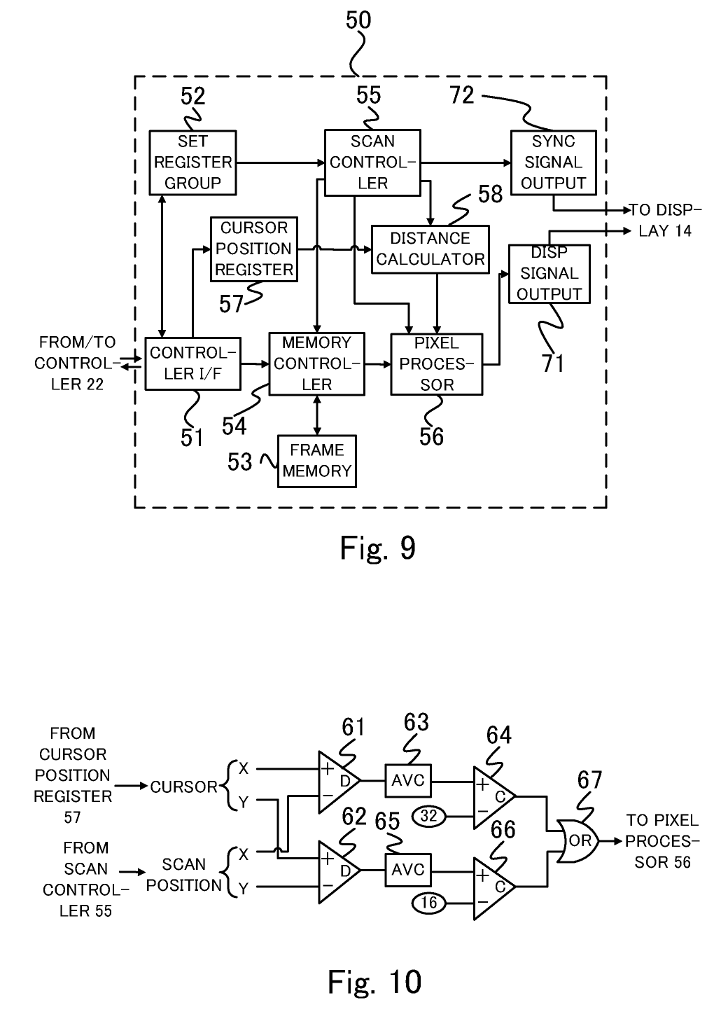

FIG. 9 is a block diagram of the display controller 50 having a controller interface 51, a set register group 52, a frame memory 53 and a memory controller 54. The set register group 52 is a collection of set registers each of which may store set values of the numbers of pixels in horizontal and vertical directions corresponding to resolution of a screen displayed on the display device 14, and of a blanking width of the screen. The frame memory 53 may store content data of the screen displayed on the display device 14 frame by frame.

The controller interface 51 may relay data to be written to or read out from one of the set registers of the set register group 52 in accordance with an instruction of the controller 22. The controller interface 51 may relay data to be written to the frame memory 53 through the memory controller 54 in accordance with an instruction of the controller 22.

The display controller 50 has a scan controller 55 and a pixel processor 56. The scan controller 55 may scan the pixels forming a screen displayed on the display device 14 on the basis of the set values of the parameters for display synchronization (the numbers of pixels in horizontal and vertical directions, and the blanking width) stored in the set register group 52. The scan controller 55 may instruct the memory controller 54 to read the display content data from the frame memory 53 for each of the pixels.

The display controller 50 has a cursor position register 57 and a distance calculator 58. The controller 22 may set a cursor position, which has been provided on the basis of an input operation done on the operation section 17, on the cursor position register 57 through the controller interface 51. The cursor position register 57 may provide the distance calculator 58 with the data representing the cursor position that has been set. The scan controller 55 may provide the distance calculator 58 with data representing a position of a pixel that the scan controller 55 is scanning. These data are expressed by the number of pixels on a 2D (X-Y) coordinate system of the screen.

FIG. 10 is a block diagram of the distance calculator 58, having subtractors 61 and 62, absolute value calculators (AVCs) 63 and 65, comparators 64 and 66, and a logical adder 67. The cursor position register may provide the subtractor 61 and the subtractor 62 with an X-coordinate and a Y-coordinate of the cursor position, respectively. The scan controller 55 may provide the subtractor 61 and the subtractor 62 with an X-coordinate and a Y-coordinate of the scan position, respectively.

The AVC 63 may be provided with an output of the subtractor 61 so as to provide the comparator 64 with an absolute value of a difference between the X-coordinates of the cursor and scan positions. The comparator 64 is provided with a reference value that is, e.g., 32. The AVC 65 may be provided with an output of the subtractor 62 so as to provide the comparator 66 with an absolute value of a difference between the Y-coordinates of the cursor and scan positions. The comparator 64 is provided with a reference value that is, e.g., 16.

If the absolute value of the difference between the X-coordinates of the cursor position and the scan position is greater than 32 pixels, the comparator 64 produces a logical output “1”. If not, the comparator 64 produces a logical output “0”. If the absolute value of the difference between the Y-coordinates of the cursor position and the scan position is greater than 16 pixels, the comparator 66 produces a logical output “1”. If not, the comparator 66 produces a logical output “0”.

The comparators 64 and 66 may provide the logical adder 67 with the above outputs. The logical adder 67 produces an output of the distance calculator 58. If the absolute value of the difference between the X-coordinates of the cursor position and the scan position is greater than 32 pixels, or if the absolute value of the difference between the Y-coordinates of the cursor position and the scan position is greater than 16 pixels, the logical adder 67 produces a logical output “1”. If not, the logical adder 67 produces a logical output “0”.

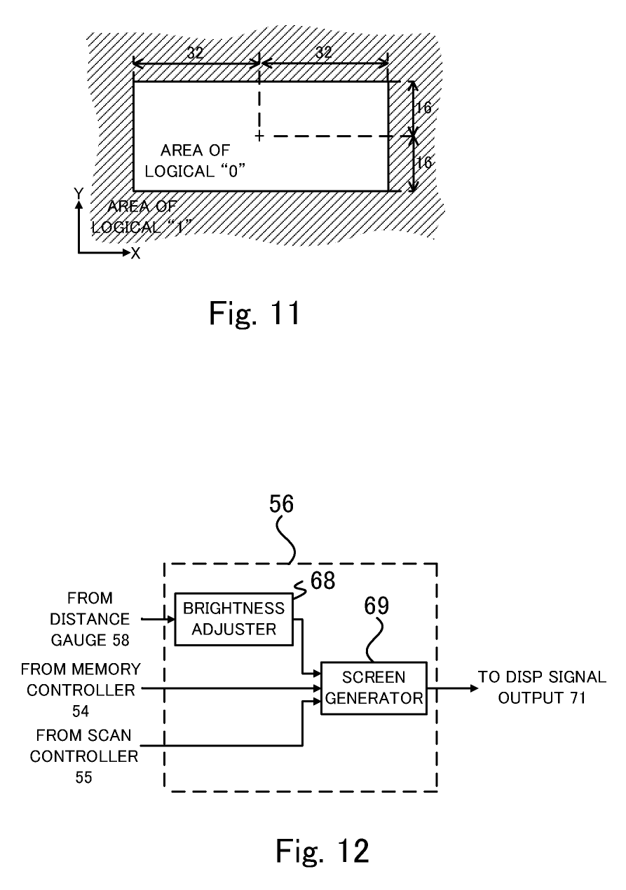

FIG. 11 illustrates the output of the distance calculator 58 on a screen. The cursor position is represented by a cross in the middle. According to the arithmetic operations described above, if the scan position is inside a rectangle centered on the cursor position and being 64 pixels and 32 pixels long in the X- and Y-directions, respectively, the distance calculator 58 produces the logical output “0”. If the scan position is outside the above rectangle (as shown by hatching), the distance calculator 58 produces the logical output “1”.

In other words, the distance produced by the distance calculator 58 may be called a scan position relative to the cursor position either in the X- or in the Y-coordinate. The output of the distance calculator 58 may be determined depending on whether the value of the above relative position is greater than 32 or 16 pixels, or neither.

FIG. 12 is a block diagram of the pixel processor 56 having a brightness adjuster 68 and a screen generator 69. The brightness adjuster 68 may adjust the brightness of the pixels so that the pixels on the outside of the rectangle shown in FIG. 11 are less bright than the pixels on the inside of the rectangle. The screen generator 69 is provided with the screen content data which the memory controller 54 has read from the frame memory 53, and is provided with a scan signal by the scan controller 55. Thus, the screen generator 69 may generate screen data on which the brightness has been adjusted. Then, in FIG. 11, the area of the screen indicated by hatching may be displayed with lower brightness than the area around the cursor.

Move back to FIG. 9, then. The display controller 50 has a display signal output unit 71 and a synchronization signal output unit 72. The screen data generated after the brightness adjustment by the pixel processor 56 may be converted into a display signal by the display signal output unit 71. The synchronization signal output unit 72 may generate a synchronization signal based on the scan of the scan controller 55, and may provide the display device 14 with the synchronization signal. The display device 14 may consequently display the screen content written in the frame memory 53 as data on the basis of the parameters set in the set register group 52, in such a way that the brightness is changed depending upon the distance to the cursor.

That is, according to the second embodiment, the outside of the noticed area including the cursor may be shown to be relatively less bright so that the noticed area may be made easy-to-see and power may be effectively saved in parallel without the layered structure of the screens of the first embodiment.

The second embodiment may be modified in such a way that the distance calculated by the distance calculator 58 is a Euclid distance in the above X-Y coordinate system. If a constant value is given as a threshold, the outside of a circle centered on the cursor and having a radius equal to the threshold may be displayed with lower brightness.

The second embodiment may also be modified in such a way that a locus of a point at a distance corresponding to a threshold from the cursor is defined as a closed plane figure surrounding the cursor. The plane figure is not limited to the rectangle shown in FIG. 11 or the circle described above, and may be an ellipse, another polygon and so on.

The second embodiment may still be modified in such a way that the brightness may further decrease if the distance calculated by the distance calculator 58 is greater than an upper threshold that is greater than the threshold. In that case, the brightness may change across three or more ranks so that the screen may enhance a visual effect.

According to the second embodiment of the present invention described above, the noticed area may be made easy-to-see and power may be effectively saved in parallel without the layered structure of the screens.

In the above description of the embodiments, the types (not limited to a mobile communication device), the shapes, the configurations, the connections, the screen displays, the logical processes, the way of defining the super-area including the noticed area and so on are considered as exemplary only, and thus may be variously modified within the scope of the present invention.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. An electronic apparatus, comprising:
a display device configured to display an image and text;
an operation section configured to be used for an input operation;
an area setting section configured to set a noticed area on a screen displayed on the display device on the basis of the input operation; and
a brightness adjuster configured to make an unnoticed area of the screen less bright than the noticed area.

2. The electronic apparatus of claim 1, wherein
the area setting section has a first layer generator, a second layer generator and a layer combiner, the first layer generator configured to generate a first layer screen on which the noticed area is set, the second layer generator configured to generate a second layer screen including a transparent portion and an opaque portion, the first layer screen and the second layer screen both shaped in accordance with a screen size of the display device, the layer combiner configured to overlap and combine the first layer screen and the second layer screen in such a way that the second layer screen is positioned in front on the display device rather than the first layer screen, and
the brightness adjuster is configured to make the first layer screen less bright than the second layer screen.

3. The electronic apparatus of claim 2, wherein the second layer generator is configured to make a display of the opaque portion of the second layer screen coincide with a display of a super-area including the noticed area set on the first layer screen.

4. The electronic apparatus of claim 2, wherein the second layer generator is configured to make a display of the opaque portion of the second layer screen coincide with a magnified display of a super-area including the noticed area set on the first layer screen.

5. The electronic apparatus of claim 3, wherein the area setting section is configured, in a case where the first layer screen is configured to display text, to set an area in which a character pointed by a cursor is positioned as the noticed area.

6. The electronic apparatus of claim 4, wherein the area setting section is configured, in a case where the first layer screen is configured to display text, to set an area in which a character pointed by a cursor is positioned as the noticed area.

7. The electronic apparatus of claim 3, wherein the area setting section is configured, in a case where the first layer screen is formed in such a way that a menu item corresponding to an area pointed by a cursor may be selected, to set the area pointed by the cursor as the noticed area.

8. The electronic apparatus of claim 4, wherein the area setting section is configured, in a case where the first layer screen is formed in such a way that a menu item corresponding to an area pointed by a cursor may be selected, to set the area pointed by the cursor as the noticed area.

9. The electronic apparatus of claim 1, wherein the area setting section has a scan controller, a cursor position register and a distance calculator, the scan controller configured to scan a plurality of pixels forming a screen displayed on the display device, the cursor position register configured to set a position of a cursor on the screen on the basis of the input operation, the distance calculator configured to calculate a distance between one of the pixels that the scan controller is scanning and the cursor, and
the brightness adjuster is configured to make the pixel which the scan controller is scanning less bright in a case where the calculated distance is greater than a determined threshold than in a case where the calculated distance is no less than the threshold.

10. The electronic apparatus of claim 9, wherein the distance calculated by the distance calculator is, in a case where a position on the screen displayed on the display device is represented in a two-dimensional coordinate system, a relative position between the pixel that the scan controller is scanning and the cursor in either one of two coordinates of the two-dimensional coordinate system.

11. The electronic apparatus of claim 9, wherein the distance calculated by the distance calculator is, in a case where a position on the screen displayed on the display device is represented in a two-dimensional coordinate system, a Euclid distance between the pixel that the scan controller is scanning and the cursor represented in the two-dimensional coordinate system.

12. The electronic apparatus of claim 9, wherein the distance calculated by the distance calculator is defined in such a way that a locus of a point at the distance corresponding to the threshold from the cursor is defined as a closed plane figure surrounding the cursor.

13. The electronic apparatus of claim 9, wherein the brightness adjuster is configured to make the pixel which the scan controller is scanning less bright in a case where the calculated distance is greater than an upper threshold that is greater than the threshold than in a case where the calculated distance is no less than the upper threshold.

14. The electronic apparatus of claim 1, wherein the display device includes a self-luminescence device.

15. The electronic apparatus of claim 2, wherein the display device includes a self-luminescence device.

16. The electronic apparatus of claim 9, wherein the display device includes a self-luminescence device.
